(19) United States
(12) Patent Application Publication
(10) Pub. No.: US 2008/0078195 A1
(43) Pub. Date: Apr. 3, 2008

(54) Automobile Switchable Solar Air-Conditioning Auxiliary System

(76) Inventors: Kuo-Len Lin, Wugu Township (TW); Tien-Chih Tseng, Wugu Township (TW); Wen-Jung Liu, Wugu Township (TW); Hai-Rui Ye, Wugu Township (TW)

Correspondence Address: HDSL, 4331 STEVENS BATTLE LANE, FAIRFAX, VA, 22033, US

(21) Appl. No.: 11/538,126

(22) Filed: Oct. 3, 2006

(51) Int. Cl. F25B 27/00; B60H 1/32

(52) U.S. Cl. 62/235.1; 62/236; 62/239

(57) ABSTRACT

An automobile switchable solar air-conditioning auxiliary system includes a solar energy supply device, a control device, a power device and an automobile air-conditioning system. During the running of a vehicle, the control device is actuated to switch to the solar energy supply device to supply the necessary electricity, whereby a motor drives a mechanical compressor of the automobile air-conditioning system to operate and thus the automobile air-conditioning system generates and introduces cold air into the vehicle. When the electricity in the solar energy supply device is insufficient, the control device automatically switches to the engine to drive the compressor. In this way, the solar energy is used as an auxiliary power supply for the automobile air-conditioning system.

### BACKGROUND OF THE INVENTION

1. Field of the Invention

The present invention relates to a solar air-conditioning auxiliary system, and in particular to an automobile air-conditioning system capable of being powered by solar energy during the running of a vehicle.

2. Description of Prior Art

When driving, many drivers like to close the windows to prevent the outside dirty air from entering the vehicle. Further, in order to keep the air inside the vehicle fresh, the automobile air-conditioning system is actuated to generate a circulation of air with the outside. However, after the automobile air-conditioning system is actuated, it has significant influence on the consumption of fuel and engine power during the running of the vehicle.

After the automobile air-conditioning system is actuated, since an electromagnetic clutch of a mechanical compressor in the air-conditioning system generates a sucking operation, the belt pulley of the mechanical compressor is driven by an engine-driven transmission belt, so that a rotor of the mechanical compressor rotates to compress the refrigerant to flow and thus the automobile air-conditioning system generates and introduces cold air into the vehicle. Since the running of the engine not only drives the vehicle, but also drives the mechanical compressor of the automobile air-conditioning system to operate, the consumption of fuel and engine power is thus increased.

Recently, the price of gasoline is continuously increasing due to the short of crude oil, many drivers turn off the automobile air-conditioning system when driving so as to reduce the consumption of fuel and engine power. Further, they like to open the windows to introduce the outside air into the vehicle in place of the cold air. Although this measure can reduce the consumption of fuel and engine power, the outside exhaust and dirt are harmful to the human body. Further, the dirt entering the vehicle also soils the interior of the vehicle.

### SUMMARY OF THE INVENTION

In view of the above problems with respect to the consumption of fuel and engine power, the present invention is thus proposed. The present invention provides an automobile air-conditioning system switchable to be powered by solar energy during the running of the vehicle. Further, when the amount of electricity converted from solar energy is insufficient, the present invention automatically switches to the engine to drive the automobile air-conditioning system, and thus the solar energy becomes an auxiliary power supply for the automobile air-conditioning system.

The automobile switchable solar air-conditioning auxiliary system of the present invention comprises:

a solar energy supply device including a solar plate, a charging unit, a battery unit and an electricity conversion unit;

a control device electrically connected to the solar energy supply device and including a micro processing unit, a voltage-sensing unit, a display unit, an operating unit, a switch unit and an inverter;

a power device including a motor and a second electromagnetic clutch; and

an automobile air-conditioning system including at least an electromagnetic clutch and a mechanical compressor.

During the running of the vehicle, the voltage-sensing unit instantaneously transmits the sensed signals of the battery unit to the micro processing unit for calculation. After the calculation of the micro processing unit, if the voltage of the battery unit is determined to be enough, the micro processing unit sends a trigger signal to synchronously actuate the switch unit and the second electromagnetic clutch. At the same time, the trigger signal sent by the micro processing unit is inverted into an inverted signal by the inverter to make the first electromagnetic clutch inactive. The power input by the electricity conversion unit drives the motor and the second electromagnetic clutch and thus drives the mechanical compressor to operate, whereby the automobile air-conditioning system generates and introduces cold air into the vehicle.

During the running of the vehicle, the voltage-sensing unit instantaneously transmits the sensed signals of the battery unit to the micro processing unit for calculation. After the calculation of the micro processing unit, if the voltage of the battery unit is determined to be insufficient, the micro processing unit immediately outputs an inversion signal to make the switch unit and the second electromagnetic clutch inactive. At this time, the motor stops and the inversion signal output by the micro processing unit is inverted into a trigger signal by the inverter, thereby to drive the first electromagnetic clutch to operate. In this way, the engine is caused to drive the mechanical compressor to operate and thus the automobile air-conditioning system generates and introduces cold air into the vehicle.

### BRIEF DESCRIPTION OF THE DRAWINGS

FIG. 1 is a block view showing the circuit of the automobile switchable solar air-conditioning auxiliary system of the present invention.

### DETAILED DESCRIPTION OF THE INVENTION

The technical contents and the detailed description of the present invention will be made with reference to the accompanying drawings.

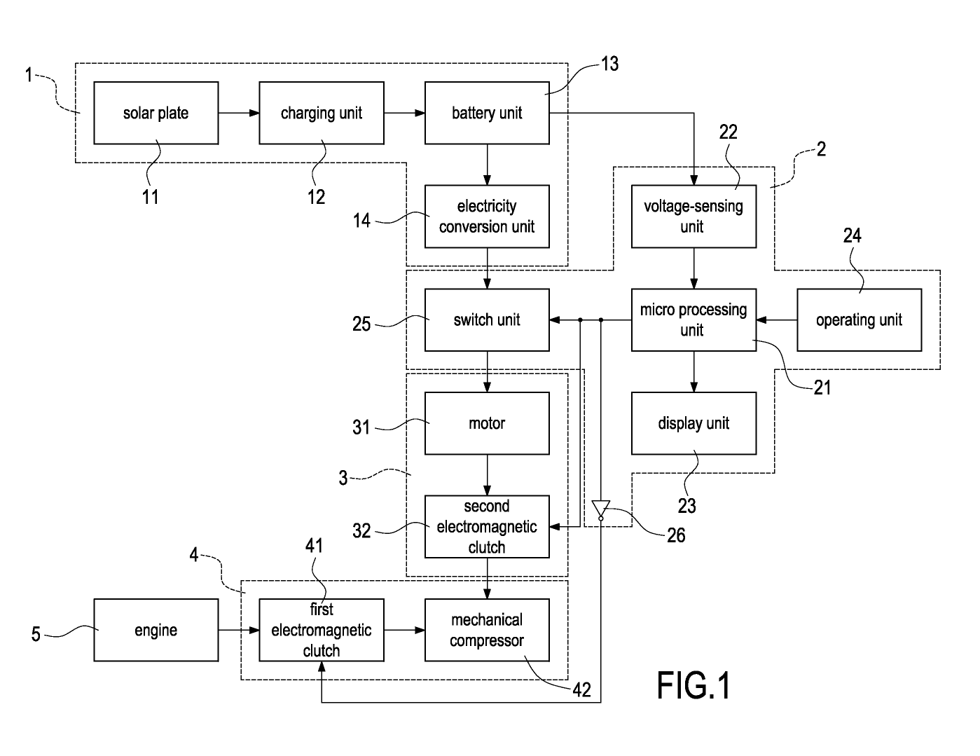

FIG. 1 is a block view showing the circuit of the automobile switchable solar air-conditioning auxiliary system of the present invention. As shown in the figure, the automobile switchable solar air-conditioning auxiliary system of the present invention comprises a solar energy supplying device 1, a control device 2 and a power device 3. During the running of the vehicle, the solar energy can be switched to actuate an automobile air-conditioning system 4, thereby to reduce the consumption of fuel and engine power.

The solar energy supply device 1 includes a solar plate 11, a charging unit 12, a battery unit 13 and an electricity conversion unit 14. The charging unit 12 is electrically connected to the solar plate 11 and the battery unit 13. The electricity conversion unit 14 is electrically connected to the battery unit 13. The solar plate 11 absorbs sunlight, converts it into electricity and then transmits the converted electricity to the charging unit 12, so that the charging unit can charge the battery unit 13 to save a voltage therein. The battery unit 13 outputs the voltage and the voltage is converted into another voltage for driving the power device 3 (DC voltage or AC voltage) via the electricity conversion unit 14, thereby to drive a mechanical compressor 42 of the automobile air-conditioning system 4 to generate and introduce cold air into the vehicle. The solar plate 11 and the charging unit 12 shown in the figure are conventional, and thus the description thereof is omitted. The battery unit 13 is an accumulator and the electricity conversion unit 14 is a transformer.

The control device 2 is electrically connected to the solar energy supply device 1 and includes a micro processing unit 21, a voltage-sensing unit 22, a display unit 23, an operating unit 24, a switch unit 25 and an inverter 26. The micro processing unit 21 serves as a control center of the whole control device 2.

The voltage-sensing device 22 is electrically connected to the micro processing unit 21 and the battery unit 13 for sensing the voltage of the battery unit 13 and transmitting the sensed signal to the micro processing unit 21 for calculation. The micro processing unit 21 can calculate the voltage of the battery unit 13.

The display unit 23 is electrically connected to the micro processing unit 21 for displaying a symbol indicative of the voltage of the battery unit 13 or a pattern showing that the automobile air-conditioning system 4 is driven by solar energy or by the engine 5. The display unit 23 shown in the figure is a liquid crystal displayer.

The operating unit 24 is constituted of a plurality of bottoms and electrically connected to the micro processing unit 21. After a starting or stopping bottom is pressed, the operating unit 24 can input operating signals for starting or stopping the control device 2.

The switch unit 25 is electrically connected to the micro processing unit 21 and the electricity conversion unit 14. After the starting bottom (not shown) of the operating unit 24 is pressed, a starting signal is output to the micro processing unit 21 for calculation. After the calculation of the micro processing unit 21, a signal is output to actuate the switch unit 25, so that the power output by the electricity conversion unit 14 can pass through the switch unit 25 to drive the motor 31 of the power device 3. Alternatively, after the stopping bottom (not shown) of the operating unit 24 is pressed, a stopping signal is output to the micro processing unit 21 for calculation. After the calculation of the micro processing unit 21, a signal is output to make the switch unit 25 inactive, so that the power output by the electricity conversion unit 14 cannot pass through the switch unit 25 and thus the motor 31 stops to operate. The switch unit 25 shown in the drawing is a relay.

The inverter 26 has an input end and an output end. The input end is electrically connected to the micro processing unit 21, and the output end is electrically connected to the electromagnetic clutch 41 of the automobile air-conditioning system 4. If the micro processing unit 21 outputs a trigger signal, the trigger signal is inverted into an inversion signal by the inverter 26. If the micro processing unit 21 outputs an inversion signal, the inversion signal is inverted into a trigger signal by the inverter 26.

The power device 3 includes a motor 31 and a second electromagnetic clutch 32. The motor 31 and the switch unit 25 are mechanically connected to the second electromagnetic clutch 32. After the switch unit 25 is actuated, the power output by the electricity conversion unit 14 can drive the motor 31 to operate.

The second electromagnetic clutch 32 is mechanically connected to the motor 31 and the mechanical compressor 42. After electrically connected to the micro processing unit 21, the micro processing unit 21 outputs a signal for actuating the switch unit 25 and synchronously driving the second electromagnetic clutch 32 to suck the motor 31. When the motor 31 is driven by the power output by the electricity conversion unit 14, the motor can also drive the mechanical compressor 42 of the automobile air-conditioning system 4 to operate, whereby the automobile air-conditioning system 4 generates and introduces cold air into the vehicle.

The automobile air-conditioning system 4 includes at least a first electromagnetic clutch 41 and a mechanical clutch 42. After the first electromagnetic clutch 41 is connected to the engine 5 and the mechanical compressor 42, it is electrically connected with the inverter 26, and the mechanical compressor 42 is connected to the first and second electromagnetic clutches 41, 32.

When the vehicle is running, the driver actuates the automobile air-conditioning system 4, so that the first electromagnetic clutch 41 generates a sucking operation. In this way, the engine 5 is caused to drive the mechanical compressor 42 to operate, whereby the automobile air-conditioning system 4 generates and introduces cold air into the vehicle.

During the running of the vehicle, the voltage-sensing unit 22 transmits the sensed signals of the battery unit 13 to the micro processing unit 21 for calculation. After the calculation of the micro processing unit 21, if the voltage stored in the battery unit 13 is determined to be enough, the micro processing unit 21 immediately sends a trigger signal to synchronously actuate the switch unit 25 and the second electromagnetic clutch 32. At the same time, the trigger signal sent by the micro processing unit 21 is inverted into an inverted signal by the inverter 26 to make the first electromagnetic clutch 41 inactive. Therefore, the power output by the electricity conversion unit 14 drives the motor 31 and the second electromagnetic clutch 32 drives the mechanical compressor 42 to operate, whereby the automobile air-conditioning system 4 generates and introduces cold air into the vehicle.

During the running of the vehicle, the voltage-sensing unit 22 transmits the sensed signals to the micro processing unit 21 for calculation. After the calculation of the micro processing unit 21, if the voltage of the battery unit 13 is determined to be insufficient, the micro processing unit 21 immediately outputs an inversion signal to make the switch unit 25 and the second electromagnetic clutch 32 inactive. At this time, the motor 31 stops and the inversion signal output by the micro processing unit 21 is inverted into a trigger signal by the inverter 26, thereby to drive the first electromagnetic clutch 41 to operate. In this way, the engine 5 is caused to drive the mechanical compressor 42 to operate and thus the automobile air-conditioning system 4 generates and introduces cold air into the vehicle.

With the timely switch control of the control device 2, the solar energy can be used as an auxiliary power supply for the automobile air-conditioning system during the running of the vehicle. In this way, the consumption of fuel and engine power can be reduced.

Although the present invention has been described with reference to the foregoing preferred embodiment, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. An automobile switchable solar air-conditioning auxiliary system for an engine-powered vehicle, the vehicle having an engine-driven air-conditioning system, the air-conditioning system having a mechanical compressor and connected to the engine via a first electromagnetic clutch, the system comprising:
a solar energy supply device for converting solar energy into electricity and outputting the converted electricity;
a control device electrically connected to the solar energy supply device and including:
a micro processing unit electrically connected to the solar energy supply device to serve as a control center of the control device;
a voltage-sensing unit electrically connected to the micro processing unit and the solar energy supply device for sensing a voltage of the solar energy supply device;
an operation device electrically connected to the micro processing unit for starting/stopping the control device;
a switch unit electrically connected to the micro processing unit and the solar energy supply device and driven by the micro processing unit to control an active or an inactive state of a power supply;
an inverter having an input end electrically connected to the micro processing unit and an output end electrically connected to the first electromagnetic clutch;
a power device including:
a motor electrically connected to the solar energy supply device via the switch unit and driven by the power output from the solar energy supply unit after the switch unit is actuated; and
a second electromagnetic clutch electrically connected to the micro processing unit and mechanically connected between the motor and the mechanical compressor;
wherein the micro processing unit selectively switches to the engine or motor to drive the mechanical compressor according to the voltage stored in the solar energy supply device sensed by the voltage-sensing unit.

2. The automobile switchable solar air-conditioning auxiliary system according to claim 1, wherein the solar energy supply device further includes;
a solar plate for converting sunlight into electricity and outputting the converted electricity;
a charging unit electrically connected to the solar plate;
a battery unit electrically connected to the charging unit for saving the DC voltage output by the charging unit; and
an electricity conversion unit electrically connected to the switch unit for converting the voltage output by the battery unit into electricity to drive the motor.

3. The automobile switchable solar air-conditioning auxiliary system according to claim 1, wherein the switch unit is a relay.

4. The automobile switchable solar air-conditioning auxiliary system according to claim 1, further comprising a display unit electrically connected to the micro processing unit.

5. The automobile switchable solar air-conditioning auxiliary system according to claim 4, wherein the display unit is a liquid crystal displayer.
